(19) United States
(12) Patent Application Publication
(10) Pub. No.: US 2026/0091827 A1
(43) Pub. Date: Apr. 2, 2026

(54) UNITARY REAR RAIL STRUCTURE FOR A VEHICLE AND METHODS

(71) Applicant: AUTOTECH ENGINEERING S.L., Amorebieta-Etxano (ES)

(72) Inventors: Masanori KISAKU, Paris (FR); Sergi MARQUEZ DURAN, Rajadell, Barcelona (ES); Martin Antonio MECA MARTÍNEZ, Santpedor, Barcelona (ES); Elaine Rilna Anak PATRICK STEWART, Kanagawa (JP); Javier VALENCIA CARRIO, Manresa (ES)

(21) Appl. No.: 19/112,742

(22) PCT Filed: Oct. 5, 2023
(86) PCT No.: PCT/EP2023/077653

§ 371 Date: Mar. 18, 2025

(30) Foreign Application Priority Data
Oct. 6, 2022 (EP) 22382942.5

(51) Int. Cl. B62D 25/08; B23K 11/11; B23K 101/00; B62D 25/20; B62D 29/00

(52) U.S. Cl. CPC B62D 25/08; B23K 11/11; B62D 25/2027; B62D 29/007; B23K 2101/006

(57) ABSTRACT

The present disclosure relates to unitary rear rail structures for a vehicle framework. The unitary rear rail structures comprise a first rear rail, a second rear rail and one or more cross-members connecting the first rear rail to the second rear rail. The unitary rear rail structure is formed by deforming a single combined blank. The single combined blank comprises at least a first blank joined to a second blank such that the first blank partially overlaps the second blank to form one or more overlapping regions. The present disclosure further relates to methods for manufacturing such unitary rear rail structures.

The present application claims the benefit of European patent application n° 22 382 942.5 filed on October 6, 2022. The present disclosure relates to unitary rear rail structures for a vehicle, the unitary rear rail structures comprising a first and second rear rail and one or more cross-members connecting the rear rails. The present disclosure further relates to methods for manufacturing such unitary rear rail structures.

### BACKGROUND

Vehicles such as cars incorporate a structural skeleton designed to withstand the loads that the vehicle may be subjected to during its lifetime. The structural skeleton is further designed to withstand and absorb impacts, in case of e.g. collisions with other cars or road structures.

The demand for weight reduction in the automotive industry has led to the development and implementation of lightweight materials or components, and related manufacturing processes and tools. The demand for weight reduction is especially driven by the goal of a reduction of CO₂ emissions. The growing concern for occupant safety also leads to the adoption of materials which improve the integrity of the vehicle during a crash while also improving the energy absorption.

A process known as Hot Forming Die Quenching (HFDQ) typically uses boron steel sheets to create stamped components with Ultra High Strength Steel (UHSS) properties, with tensile strengths of e.g. 1.500 MPa or 2.000 MPa or even more. The increase in strength allows for a thinner gauge material to be used, which results in weight savings over conventionally cold stamped mild steel components. Throughout the present disclosure UHSS may be regarded as a steel having an ultimate tensile strength of 1.000 MPa or more after a press hardening process.

In a HFDQ process, a blank to be hot formed may be heated to a predetermined temperature e.g. austenization temperature or higher (and particularly between Ac3 and an evaporation temperature of e.g. a coating of the blank). A furnace system may be used for this purpose. Depending on the specific needs, a furnace system may be complemented with additional heaters, e.g. induction heaters or infrared heaters. By heating the blank, the strength of the blank decreases, and deformability increases i.e. to facilitate the hot stamping process.

There are several known Ultra High Strength steels (UHSS) for hot stamping and hardening. The blank may be made e.g. of a boron steel, coated or uncoated, such as Usibor® (22MnB5) commercially available from ArcelorMittal.

Hot Forming Die Quenching may also be called “press hardening” or “hot stamping”. These terms will be used interchangeably throughout the present disclosure.

Typical vehicle components that may be manufactured using the HFDQ process include door beams, bumper beams, cross/side members, A/B pillar reinforcements, front and rear rails, seat crossmembers and roof rails.

Hot forming of boron steels is becoming increasingly popular in the automotive industry due to their excellent strength and formability. Many structural components that were traditionally cold formed from mild steel are thus being replaced with hot formed equivalents that offer a significant increase in strength. This allows for reductions in material thickness (and thus weight) while maintaining the same strength. However, hot formed components offer very low levels of ductility and energy absorption in the as-formed condition.

In order to improve the ductility and energy absorption in specific areas of a component, it is known to introduce softer regions within the same component. This improves ductility locally while maintaining the required high strength overall. By locally tailoring the microstructure and mechanical properties of certain structural components such that they comprise regions with very high strength (very hard), i.e. high ultimate tensile strength and high yield strength and regions with increased ductility (softer), i.e. lower ultimate tensile strength and lower yield strength and increased elongation before break, it may be possible to improve their overall energy absorption and maintain their structural integrity during a crash situation and also reduce their overall weight. Such soft zones may also advantageously change the kinematic behavior in case of a collapse of a component under an impact.

Known methods of creating regions with increased ductility (“softzones” or “soft zones”) in structural components of vehicles include the provision of tools comprising a pair of complementary upper and lower die units, each of the units having separate die elements (steel blocks). A blank to be hot formed is previously heated to a predetermined temperature e.g. austenization temperature or higher by, for example, a furnace system so as to reduce the strength i.e. to facilitate the hot stamping process.

The die elements may be designed to work at different temperatures, in order to have different cooling rates in different zones of the part being formed during the quenching process, and thereby resulting in different material properties in the final product e.g. soft areas which will generally have a lower ultimate tensile strength and a lower yield strength but allow for more elongation before breaking. E.g. one die element may be cooled in order to quench the corresponding area of the component being manufactured at high cooling rates and to thereby reduce the temperature of the component rapidly and obtain a hard martensitic microstructure. Another neighboring die element may be heated in order to ensure that the corresponding portion of the component being manufactured cools down at a lower cooling rate, in order to obtain a softer microstructure, including e.g. bainite, ferrite and/or perlite. Such an area of the component may remain at higher temperatures than the rest of the component when it leaves the die.

Other methods for obtaining hot stamped components with areas of different mechanical properties include e.g. tailored or differentiated heating prior to stamping, and local heat treatments after a stamping process to change the local microstructure and obtain different mechanical properties. Yet further possibilities include the use of patchwork blanks, and Tailor Welded Blanks (TWB) combining different thicknesses and/or materials in blanks.

Several methods of differential heating prior to stamping are known. In an example, a nozzle or set of nozzles may discharge a fluid stream, e.g. compressed cooling air, towards a portion of the blank to be cooled e.g. while the bank is still in a furnace system. Other parts of the blank may be maintained at a higher temperature. This makes it possible to obtain a blank with a tailored temperature profile along its length and/or width. In some examples, the blank may undergo further heating in the oven before being subjected to the stamping process.

In other examples, an array of infrared heaters may be used which may be independently controlled to control temperatures along a blank.

Some elements of the structural skeleton of a car e.g. pillars (A-pillar, B-pillar, C-pillar), unitary door ring, a rocker, a floor, and a weave rocker among others, may have one or more regions with a substantially U-shaped (also known as “hat”-shaped) cross-section. These structural components may be manufactured in a variety of ways and may be made of a variety of materials. Lightweight materials that improve the energy absorption during a crash while also keeping the integrity of the vehicle are desired.

Throughout the present disclosure, a U-shaped cross-section may be understood as relating to a structural member which in a cross-section (generally in a transverse plane which is substantially perpendicular to a longitudinal axis of the structural member) has a bottom wall and two side walls. The U-shaped cross-section is generally known for having a good ratio of moment of inertia to weight. The two side walls may form an obtuse angle with the bottom wall, e.g. between 90° and 135°. The two side walls may include outwardly extending side flanges. The bottom wall and side walls may be substantially straight, but they may also include transitions, curved portions, recesses or protrusions.

In addition to the Ultra High Strength Steels mentioned before, more ductile steels may be used in parts of the structural skeleton requiring energy absorption. Examples of ductile steels include Ductibor® 500, Ductibor® 1000 and CRL-340LA.

UHSS may exhibit tensile strengths as high as 1.500 MPa, or even 2.000 MPa or more, particularly after a press hardening operation. Once hardened, a UHSS may have a martensitic microstructure. This microstructure enables an increased maximum tensile and yield strength per weight unit.

Some ductile steels may also be heated and pressed (i.e. used in a hot stamping process) but will not have a martensitic microstructure after the process. As a result, they will have lower tensile and yield strength than UHSS, but they will have a higher elongation at break.

Although ductile steel enables energy absorption by a structural component, controlling and predicting how the structural component may behave during a vehicle crash may not be easy. Moreover, the overall weight of the vehicle framework is preferably as low as possible to reduce fuel consumption. Also, enhancing energy absorption while maintaining a certain structural integrity of the structural component is not straightforward.

The present disclosure aims to provide improvements in the terms of weight reduction and control of the deformation and energy absorption by a unitary rear rail structure for a vehicle framework when subjected to a load.

### SUMMARY

In a first aspect, a unitary rear rail structure for a vehicle framework is provided. The unitary rear rail structure comprises a first rear rail, a second rear rail and one or more cross-members connecting the first rear rail to the second rear rail. The unitary rear rail structure is formed by deforming a single combined blank. The single combined blank comprises at least a first blank joined to a second blank, such that the first blank partially overlaps the second blank to form one or more overlapping regions.

In accordance with this aspect, a structure with a simplified manufacturing process is provided. Since the unitary rear rail structure is manufactured by deforming a single blank, the manufacturing time and associated costs may be reduced. Further, other manufacturing post-processes such as welding, which may affect the mechanical properties of the component, are avoided. At the same time, the structure provided can have sufficient strength, stiffness, and energy absorption to provide protection to the passengers of the vehicle in the case of an impact, e.g., a rear impact.

As the combined blank which is formed into the unitary rear rail structure is composed of several blanks, these may be configured to both absorb energy in an impact and transfer the impact loads towards suitable areas of the vehicle framework. Thus, the structure provided can prevent deformation in the safety zone inside the vehicle. The blanks that together form the combined blank are herein called “blanks”, but might also be considered “sub-blanks”, meaning a blank that forms part of a larger blank. One or more of the individual blanks that are combined into the combined blank may comprise smaller blanks or sub-blanks as well.

Furthermore, the provision of overlapping regions may locally increase the mechanical properties of these regions of the structure, and tailor strength and stiffness as needed in the structure. Thereby, the overall strength of the structure per weight unit can be improved. At the same time, the overlapping regions may provide a local limit to the deformation, preserving the internal space of the vehicle.

Throughout the present disclosure, references to the “mechanical properties of a portion” may be understood as the mechanical properties of the material forming said portion. Therefore, unless otherwise stated, comparisons of mechanical properties of portions, components, or others, are directed to the material and not to the geometry, or other particularities, of the same.

Higher mechanical properties may herein be understood as a higher ultimate tensile strength and/or a higher yield strength, whereas lower mechanical properties may be understood as a lower ultimate tensile strength and/or a lower yield strength. Ultimate tensile strength and yield strength are herein regarded as material properties of the material after the manufacturing process. Ultimate tensile strength and yield strength may be determined in standardized tensile strength tests, using e.g. A30, A50 or A80 specimens in a quasi-static load test.

The comparison between lower and higher mechanical properties should be made using the same test conditions and specimen size. To compare yield strengths of different portions, specimens formed with the same materials as the portions of the main soft zone may be prepared and tested in a Universal Testing Machine (UTM).

In examples, the unitary rear rail structure may be made by hot stamping, and the structure may be formed in a single forming step. Further if desired, when applying hot stamping, different regions of the structure may be subjected to different temperature treatments, resulting in regions with different mechanical properties.

In examples, the overlapping regions substantially correspond to one or more transitions between one of the rails and one of the cross-members. This results in a connection between rail and cross-member with improved mechanical properties and enhances the overall kinematic behavior of the structure. Thus, the transitions between a rail and a cross-member may be designed to have higher mechanical properties than the remainder of the unitary rear rail structure.

In some examples, the first and second rear rails comprise a first region configured for attaching the unitary rear rail structure to a chassis. Further, the first region has an ultimate tensile strength after hot stamping of 1.500 MPa or more. This provides a secure connection between the unitary rear rail structure and a chassis of the vehicle and creates a robust load path to transfer loads from an impact point to certain components of the vehicle framework.

In some examples, the first and second rear rails comprise a second region which is more ductile than the first region. The second region might have an ultimate tensile strength after hot stamping between 700-1200 MPa, and a yield strength after hot stamping between 500-900 MPa. This second region, being more ductile than the remainder of the rear rails, may enhance the absorption of energy during an impact. This may reduce the accelerations of the vehicle after the impact and allows controlling the deformation of the rails and avoiding the loads or deformation reaching other regions of the unitary rear rail structure.

In examples, the first and second regions have a different microstructure. This may be achieved by applying a different temperature treatment to the first and second regions. Thus, in examples, one blank with a substantially homogenous material composition may be used to form a rear rail with separate regions of different mechanical properties.

In some examples, the single combined blank may comprise different thicknesses and/or materials. A region with increased thickness may be located where the loads and concentration of stresses may be higher in case of an impact. Specifically a region of increased thickness may be formed by overlapping two blanks. Further, materials with high mechanical properties may be located in regions where the deformations of the structure are intended to be reduced. On the other hand, materials with low mechanical properties may be located in regions intended to absorb impact energy and deform during an impact.

In some examples, at least one of the rails and the cross-members of the unitary rear rail structure has a substantially U-shaped cross-section. The U-shaped cross-section comprises a bottom wall, a first side wall, a second side wall, a first lateral flange projecting outwardly at an end of the first side wall and a second lateral flange projecting outwardly at an end of second side wall. The U-shaped cross-section increases the moment of inertia of the regions where it is formed and improves the resistance of the member against impacts, specifically impacts at an angle relative to a longitudinal direction of the member.

In examples, the unitary rear rail structure may further comprise a cover plate attached to a rear rail, and substantially closing the U-shaped cross-section. The cover plate may be made of the same or a different material than the rear rails and may enhance the energy absorption and stiffness of the unitary rear rail structure.

In some examples, the unitary rear rail structure may also include at least a part of a floor panel. For example, the rear rails may be connected to each other by a part of a floor panel. In examples, the floor panel may be formed by a blank which is joined to the other blanks to form the combined blank. The floor panel may comprise any of the features regarding materials etc. disclosed herein in relation with the rear rails and with the cross-members. In examples, the floor panel may be integrated in a cross-member, i.e. it may have a structural member connecting the first and second rear rails.

In a further aspect, a method for manufacturing a unitary rear rail structure for a vehicle framework as described in this disclosure is provided. The unitary rear rail structure comprises a first and a second rear rail and one or more cross-members

The method comprises providing a combined blank. The method further comprises providing a first blank and a second blank and arranging the first and second blanks such that the first blank partially overlaps the second blank in an overlapping region. Further, the method comprises joining the first blank to the second blank at the overlapping region to form a combined blank. In addition, the method includes heating the combined blank at least partially to above an austenization temperature, and press hardening the heated combined blank to form the unitary rear rail structure.

This method may reduce manufacturing costs associated with multi-component structures that require several manufacturing and assembly steps. Thus, the method disclosed allows reducing manufacturing time and floor space in manufacturing facilities among others. Further, this method provides a unitary rear rail structure with enhanced mechanical properties both in terms of impact resistance and deformation behavior. Additionally, the method disclosed provides a unitary rear rail structure with improved impact protection to weight ratio compared with alternative approaches.

A combined blank is to be understood herein as a blank, e.g. a metal sheet or flat metal plate that will form the main member. The combined blank may at least partially be made of hardenable steel, specifically boron steel. A thickness of the combined blank may be typically between 1 and 2.5 mm. The combined blank may be made by joining two or more blanks to each other. The blanks making up the combined blank may themselves be made of further (sub-blanks), e.g. one of the blanks making up the combined blank which is joined to another blank by overlapping may itself be a Tailor Welded Blank (TWB).

In some examples of the method, at least one of the overlapping regions between the first blank and the second blank may substantially correspond to a transition between a rail and a cross-member. Traditionally, the rails and cross-members are separately manufactured and joined to each other. By joining several blanks to obtain a single integrally formed rear rail structure, some material is lost at the transitions between the rail and cross-member. To compensate for this loss of material, locally the strength can be increased by increasing the thickness by creating an overlapping region exactly where needed. Such an overlap may be relatively small and thus more effective than the use of a Tailor Welded Blank (TWB) in which a different material or thickness would be needed over a larger area. It is also more efficient and effective than e.g. High Pressure Die Casting of aluminum, which requires a lot of aluminum to achieve the same strength as e.g. a hot stamped UHSS component.

In some examples of the method, the first and second blanks may be attached together by spot welding.

In some further examples, a first region of the unitary rear rail structure may have an ultimate tensile strength after press hardening of 1.500 MPa or more. Further, a second region of the unitary rear rail structure may have an ultimate tensile strength after press hardening between 700-1200 MPa.

Thus, a first region may be configured to substantially withstand the loads during an impact. Therefore, the first region may be a region configured to connect the unitary rear rail structure with other structural components of the vehicle, e.g. a chassis. Further, the second region may be configured to absorb energy and deform during an impact, to mitigate the accelerations experienced by the passengers of the vehicle and limit the transmission of loads to other components of the vehicle.

In some examples, the first region of the combined blank is subjected to a different heat treatment than the second region of the combined blank. This allows forming regions with different mechanical properties, e.g. due to differences in microstructure.

### BRIEF DESCRIPTION OF THE DRAWINGS

Non-limiting examples of the present disclosure will be described in the following, with reference to the appended figures, in which:

FIG. 1 schematically illustrates a bottom view of an example of a unitary rear rail structure for a vehicle according to the present disclosure;

FIG. 2 schematically illustrates an exploded view of a portion of another example of a unitary rear rail structure according to the present disclosure;

FIG. 3 schematically illustrates a cross-section view across the plane A-A′ in FIG. 1;

FIG. 4 schematically illustrates a cross-section view of another example of a unitary rear rail structure according to the present disclosure;

FIG. 5 schematically illustrates another example view of a portion of another example of a unitary rear rail structure;

FIG. 6A schematically illustrates a top view of another example of a unitary rear rail structure for a vehicle according to the present disclosure;

FIG. 6B schematically illustrates a bottom perspective view of the example of a unitary rear rail structure in FIG. 6A;

FIG. 7A schematically illustrates a single blank prior to forming another example of a unitary rear rail structure;

FIGS. 7B and 7C schematically illustrate a portion of a resulting component after hot stamping of the single blank of FIG. 7A;

FIG. 8 schematically illustrates a single blank prior to forming a further example of a unitary rear rail structure;

FIG. 9 is a flow chart of a method for manufacturing a structural component at least partially configured for supporting bending loads.

The figures refer to example implementations and are only be used as an aid for understanding the claimed subject matter, not for limiting it in any sense.

### DETAILED DESCRIPTION OF EXAMPLES

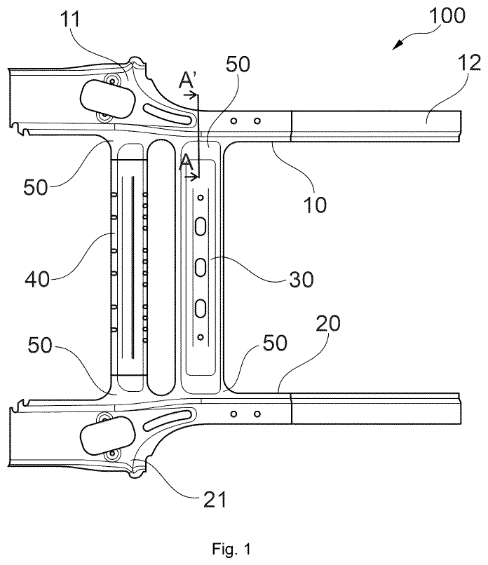

FIG. 1 schematically illustrates a bottom view of an example of a unitary rear rail structure 100 for a vehicle framework. The unitary rear rail structure 100 comprises a first rear rail 10, a second rear rail 20 and one or more cross-members 30, 40 connecting the first rear rail 10 to the second rear rail 20. Further, the unitary rear rail structure 100 is formed by deforming a single blank. The single blank comprises at least a first blank joined to a second blank such that the first blank partially overlaps the second sub-blank to form one or more overlapping regions 50.

In the example illustrated in FIG. 1, the unitary rear rail structure 100 comprises two cross-members 30, 40, but other numbers of cross-members may be used in other examples. For example, the unitary rear rail 100 may comprise only one cross-member, or three or more cross-members. Additionally, the cross-members 30, 40 may be distributed in a different manner, e.g. the separation between cross-members 30, 40 may be increased or reduced depending on the specifications of the unitary rear rail structure 100.

Since the rear rail structure as disclosed herein is made of a unitary (integrally formed) element, there are no separate components that qualify as rail or cross-member and the boundaries between them are less clear. Therefore, the term “rail portion” and “cross-member portion” may be used to denote portions of the same element that function as a rail or as a cross-member.

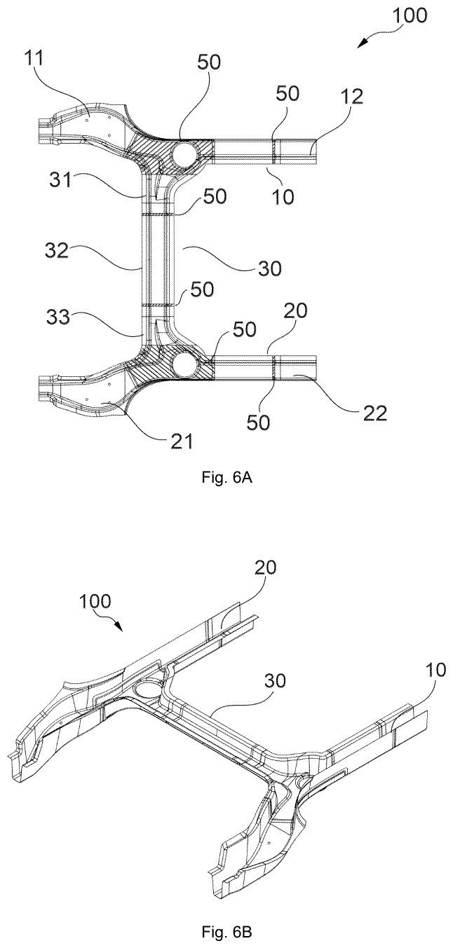

In the illustrated example, the unitary rear rail structure 100 may be made by hot stamping. For example, it may be made in a direct hot stamping manufacturing process or in an indirect hot stamping manufacturing process. In other examples, the unitary rear rail structure 100 may be manufactured by cold stamping or by other manufacturing process. Further details on the manufacturing process of a component will be described in relation to FIGS. 6 to 8.

In some examples, the unitary rear rail structure 100 may be made of a boron steel like Usibor®, e.g. Usibor® 1500 (or any 22MnB5 steel with or without protective coating), Usibor®2000 (or any 37MnB5 steel) or any martensitic steel or ultra-high strength steel (UHSS). Usibor® is commercially available from ArcelorMittal.

Usibor® 1500 is supplied in ferritic-perlitic phase. It is a fine grain structure distributed in a homogenous pattern. Its mechanical properties are related to this structure. After heating, a hot stamping process and subsequent quenching, a martensite microstructure is created. As a result, tensile strength and yield strength increase noticeably.

The composition of Usibor® 1500 is summarized below in weight percentages (the rest is iron (Fe) and impurities):
Maximum carbon (C) (%): 0.25
Maximum silicon (Si) (%): 0.4
Maximum manganese (Mn) (%): 1.4
Maximum phosphorus (P) (%): 0.03
Maximum sulphur(S) (%): 0.01
Aluminium (AI) (%): 0.01-0.1
Maximum titanium (Ti) (%): 0.05
Maximum niobium (Nb) (%): 0.01
Maximum copper (Cu) (%): 0.20
Maximum boron (B) (%): 0.005
Maximum chromium (Cr) (%): 0.35

Usibor® 2000 is another boron steel with even higher strength. After a hot stamping die quenching process, the yield strength of Usibor® 2000 may be 1300 MPa or more, and its ultimate tensile strength may be above 1800 MPa.

The composition of Usibor® 2000 is summarized below in weight percentages (rest is iron (Fe) and impurities):
Maximum carbon (C) (%): 0.36
Maximum silicon (Si) (%): 0.8
Maximum manganese (Mn) (%): 0.8
Maximum phosphorus (P) (%): 0.03
Maximum sulphur(S) (%): 0.01
Aluminium (AI) (%): 0.01-0.06
Maximum titanium (Ti) (%): 0.07
Maximum niobium (Nb) (%): 0.07
Maximum copper (Cu) (%): 0.20
Maximum boron (B) (%): 0.005
Maximum chromium (Cr) (%): 0.50
Maximum molybdenum (Mb) (%): 0.50

22MnB5 may be presented with an aluminum-silicon coating in order to avoid decarburization and scale formation during the forming process.

Several 22MnB5 steels are commercially available having a similar chemical composition. However, the exact amount of each of the components in a 22MnB5 steel may vary slightly from one manufacturer to another. Other ultra-high strength steels include e.g. BTR 165, commercially available from Benteler.

In examples, the unitary rear rail structure 100 may comprise members made of different materials. For example, the first and second rear rail 10, 20 may be made of UHSS, e.g. 22MnB5 or another boron steel, in one region and a more ductile steel in another region, and the cross-member 30 may be made from an UHSS.

Also, the types of UHSS may be varied depending on the requirements, e.g. 22MnB5 or Usibor® 1500 may be used for the stiffer regions of the rails, and a fist and second cross-member 30, 40 could be made of e.g. 37MnB5 or Usibor® 2000. Other materials may be chosen to form a unitary rear rail structure 100 depending on the desired dynamic response and mechanical properties. Additionally, a given member may have regions made of different materials. For example, the first and second rear rail 10, 20 may have a first region 11 made of Usibor® 2000 and a second region 12 made of Usibor® 1500, or Ductibor® 1000.

Ductibor® is a steel material with much higher ductility than Usibor® materials, and components made of this material can be effective for absorbing energy during an impact. The yield strength of Ductibor® 500 may be 400 MPa or more, and the ultimate tensile strength of 550 MPa or more.

The composition of Ductibor® 500 is summarized below in weight percentages (rest is iron (Fe) and impurities):
Maximum carbon (C) (%): 0.1
Maximum silicon (Si) (%): 0.5
Maximum manganese (Mn) (%): 1.7
Maximum phosphorus (P) (%): 0.03
Maximum sulphur(S) (%): 0.025
Aluminium (AI) (%): 0.015-0.2
Maximum titanium (Ti) (%): 0.09
Maximum niobium (Nb) (%): 0.10
Maximum copper (Cu) (%): 0.20
Maximum boron (B) (%): 0.001
Maximum chromium (Cr) (%): 0.20

The yield strength of Ductibor® 1000 may be 800 MPa or more, and the ultimate tensile strength of 1000 MPa or more. The composition of Ductibor® 1000 is summarized below in weight percentages (rest is iron (Fe) and impurities):
Maximum carbon (C) (%): 0.10
Maximum silicon (Si) (%): 0.6
Maximum manganese (Mn) (%): 1.8
Maximum phosphorus (P) (%): 0.03
Maximum sulphur(S) (%): 0.01
Aluminium (Al) (%): 0.01-0.1
Maximum titanium (Ti) (%): 0.05
Maximum niobium (Nb) (%): 0.10
Maximum copper (Cu) (%): 0.20
Maximum boron (B) (%): 0.005
Maximum chromium (Cr) (%): 0.20

As illustrated in FIG. 1, the overlapping regions 50 may substantially correspond to one or more transitions between one of the rails 10, 20 and one of the cross-members 30, 40. Thus, the mechanical properties of the connection between members are improved. A transition between a rail portion and a cross-member is the area wherein a rail portions meets a cross-member portion, or in other words, the area changing from a substantially longitudinally arranged body to a substantially transversely arranged body.

In this illustrated example, the first and second rear rails 10, 20 may comprise a first region 11, 21 configured for attaching the unitary rear rail structure 100 to a chassis. The stiffness and strength required in the region joined to the chassis may be higher. The first region 11, 21 may be made of a suitable UHSS, like 22MnB5 or similar and may have an ultimate tensile strength after hot stamping above 1.500 MPa or more, and more specifically 1.800 MPa or more.

Further, the first and second rear rails 10, 20 may also comprise a second region 12, 22 having an ultimate tensile strength after hot stamping between 700-1200 MPa, and a yield strength after hot stamping between 500-900 MPa. These second regions 12, 22 may be configured to absorb energy and deform during an impact. These second regions 12, 22 may be made of Ductibor® or another suitable steel that is more ductile than the steel for the first region. The transition between the second regions 12, 22 and the remainder of the rear rails may comprise an overlapping region. In other examples, the second regions 12, 22 and the remainder of the rear rails 10, 20 may be formed as Tailor Welded Blanks, i.e. the individual blanks may be welded to each other in an edge-to-edge welding process (“butt joint”).

Further, different regions of the unitary rear rail structure 100 may be made using blanks of the same (base) material, but with a different local microstructure. For example the first and second regions 11, 21, 12, 22 may be made with a material, with substantially the same composition but with different local microstructure. This may be obtained by applying different thermal treatment, before, during or after the stamping process. E.g. local heat treatments using induction heating or laser after a stamping process may result in regions 11, 21, 12, 22 with different mechanical properties.

In the example illustrated in FIG. 1, the first regions 11, 21 of the rear rails 10, 20 may have a martensitic microstructure, and the second regions 12, 22 of the rails may have a microstructure including bainite, ferrite and/or perlite.

The overlapping regions 50 may have a width between 10 mm and 100 mm, specifically between 20 mm and 60 mm, and more specifically 20-50 mm. I.e. an overlapping region may extend over the whole width of the cross-member 30 and extend into the rail portion by e.g. 20-60 mm.

An area of an overlapping region at the transition between one of the rear rails and the cross-member may be e.g. 20-600 cm², specifically 30-500 cm², more specifically between 40 and 450 cm².

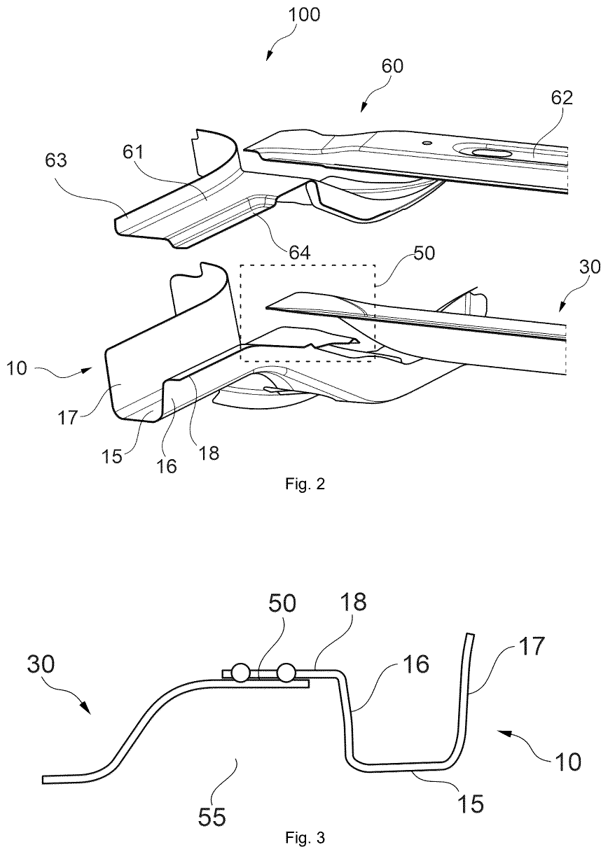

FIG. 2 schematically illustrates an exploded view of a portion of another example of a unitary rear rail structure 100 according to the present disclosure. The exploded view illustrates a first rear rail 10 and a cross-member 30. It should be clear that even though the rail and cross-member are illustrated as separate components in this exploded view, in reality they are formed as a single unitary structure.

FIG. 2 shows an overlapping region 50 between these two members. As can be seen, the first rear rail 10 and the cross-member have a mating geometry within the overlapping region 50 as a result of a single forming operation. Note that the overlapping region 50 has been marked with a rectangular box with broken lines and is only partially shown here as the overlapping region 50 may extend over the whole width of the cross-member 30.

FIG. 2 further illustrates that the first rear rail 10 may have a substantially U-shaped cross-section. The U-shape has a bottom wall 15, a first side wall 16, a second side wall 17 and a first lateral flange 18 projecting outwardly at an end of the first side wall 16. Although not shown, the U-shaped cross-section may also have a second lateral flange projecting outwardly at an end of second side wall 17 in this example (e.g. in another longitudinal position) or in other examples.

In some examples, the lateral flange(s) 18 may have a different microstructure than the side wall(s) to which they are attached. More specifically, the lateral flange(s) may have lower mechanical properties than the lateral wall(s) where they are located to facilitate the connection with other components such as other vehicle framework components. E.g. a local heat treatment may be performed on parts of the flanges where they are joined to adjoining structures or differentiated cooling may be applied in a hot pressing apparatus.

FIG. 2 shows that the cross-member 30 may also have a U-shaped cross-section. Further, any member of the unitary rear rail structure 100 may define other cross-section geometries. For example, any member of the unitary rear rail structure 100 may define a L-shaped cross-section along at least a part of its length, a W-shaped cross-section along a portion of its length or other cross-sections.

Although not shown in the example of FIG. 2, the bottom wall 15 may be curved or comprise recesses or protrusions along the bottom. This also applies to the side walls 16, 17, which are not necessarily completely straight. The side walls 16, 17 may include straight portions with a curved transition zone between straight portions. In addition, the side walls 16, 17 may or may not be symmetrical. For example, a height of the first side wall 16 may be different from a height of the second side wall 17. In some examples, a height along the longitudinal direction of the first and/or second side walls 16, 17 may also vary. In examples, a width of the bottom wall 15 may also vary along the longitudinal direction of the bottom wall 15. Further, the width of the bottom wall 15 may be different from a height of the first and/or second side walls 16, 17. Other examples may include any combination of the above examples.

FIG. 2 also shows that the unitary rear rail structure may include a cover plate 60. The cover plate 60 may be formed by one or more cover components 61, 62. In fact, in the present example, the cover plate 60 comprises a first cover component 61 configured to close the U-shaped cross-section of the first rear rail 10 and a second cover component 62 configured to close the U-shaped cross-section of the cross-member 30. As mentioned before, the cover plate 60 may be also manufactured in a single forming step. The cover plate 60 may be shaped to at least partially close the cross-section (U-shape or other), of the members to increase stiffness, specifically torsional stiffness.

In the example illustrated in FIG. 2, the first cover component 61 comprises a vertical flange 63 configured to be coupled with a vertical region of the second side wall 17 of the first rear rail 10. Further, the first cover component 61 comprises a horizontal flange 64 configured to the coupled with a first flange 18 of the rear rail 10. Thus, the first cover component 61 may be coupled to the first rear rail 10 through the flanges 63, 64 by welding. In addition, the second cover component 62 may be coupled to the cross-member 30 in a similar manner, i.e. through flanges by welding. Both remote laser welding and spot welding might be used.

Further, the first and second cover components 61, 62 may have different mechanical properties. In fact, a cover component 61, 62 may also have regions with different mechanical properties, e.g. a flange 63, 64 may be made of a material with lower mechanical properties than the remainder of the cover component 61. Other numbers of cover components, i.e. three or more, as well as other relative sizes and geometries may be included in the cover plate 60 according to the present disclosure.

FIG. 3 schematically illustrates a cross-section view across the plane A-A′ in FIG. 1. FIG. 3 shows the transition between a portion of the first rear rail 10 and a portion of the cross-member 30, but the same can apply to the transition between other members of the unitary rear rail structure 100. In the example, the first rear rail 10 comprises a U-shaped cross-section with a bottom wall 15, a first side wall 16, a second side wall 17, and a first lateral flange 18 projecting outwardly at an end of the first side wall 16. The flange 18 overlaps with a portion of the cross-member 30 to form an overlapping region 50.

In this example, the flange 18 of the rail portion and the cross-member 30 are attached together by spot welding. Note that the spot welds 51 have been schematically illustrated as circular dots. A plurality of spot welds 51 may be used to connect the first rear rail 10 with the cross-member 30. Other joining techniques, and specifically other welding techniques such as laser welding may be used in other examples. It should also be noted that, whereas the spot welds are indicated in the final product, in reality the spot welding (or other joining) takes place before deforming the blanks, i.e. before the hot stamping process. Welding may thus be carried out on flat blanks which makes welding easier.

As previously discussed, the width of the overlapping region 50 can be adapted to the specifications of the structure 100. Thus, the width may be increased when the unitary rear rail structure 100 is designed to withstand higher impact loads, e.g. the mass of the vehicle is higher.

FIG. 3 also shows that the connection between the cross-member 30 and the first rear rail 10 leaves a vacant space 55 where other vehicle components may be located, e.g. electronic components. In this example, an aspect of making the rear rail structure as a unitary structure creates extra space for vehicle components.

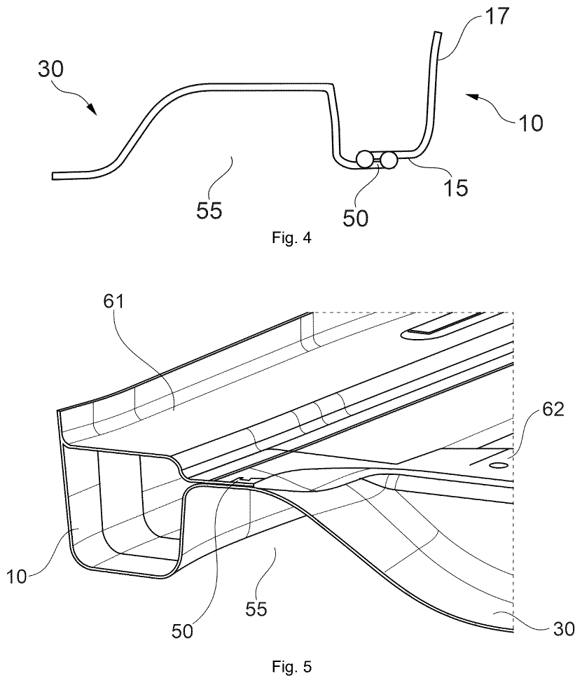

FIG. 4 shows a cross-sectional view as in FIG. 3, but for another example of unitary rear rail structure 100. More precisely, the unitary rear rail structure 100 in FIG. 4 comprises an overlapping region 50 located at a bottom wall 15 of a rear rail with U-shaped cross-section. As discussed in relation with FIG. 3, a plurality of spot welds 51 may be used to connect the structural members.

In the example shown in FIG. 4, the combined blank which is deformed to form the unitary rear rail structure 100 is formed from a plurality of blanks. Thus, a first blank may be shaped with a substantially L-shaped cross-section and a second blank may shaped such that to mate with the first blank and form a U-shaped rear rail 10. Additionally, the second blank may also form a U-shaped cross-section (not visible in the illustrated view).

FIG. 5 schematically illustrates another portion of a further example of a unitary rear rail structure 100 comprising a cover plate 60. In this example, the unitary rear rail structure 100 comprises a first rear rail 10 and a cross-member 30, both with a closed section. The second rear rail (not illustrated) may also have a closed section. Further, FIG. 6 shows that the overlapping region 50 substantially corresponds to a transition between a rail 10 and a cross-member 30, and that the arrangement between these structural members can provide a vacant space 55 where other components of the vehicle may be placed, e.g. electronic components.

As discussed in relation with FIG. 2, the closed section may be formed by attaching a cover plate 60 to the rear rails and the cross-members, e.g. to a first rear rail 10 and a cross-member 30 both with a U-shaped cross-section. The cover plate 60 may be attached to the rear rails and cross-members by spot welding.

FIGS. 6A and 6B schematically illustrate another example of a unitary rear rail structure 100 for a vehicle according to the present disclosure. FIG. 6A illustrates a top view of the unitary rear rail 100 and FIG. 6B a bottom perspective view of the unitary rear rail 100.

In the example in FIG. 6A, the overlapping regions 50 have been illustrated with oblique lines.

FIG. 6A shows that the unitary rear rail structure 100 comprises a first rear rail 10 a second rear rail 20 and a cross-member 30. The unitary rear rail structure 100 may be made by hot stamping a single (combined) blank. In this example, the combined blank is made of seven smaller blanks: two blanks for each of the rails, and three blanks making up the cross-member.

The cross-member 30 of the unitary rear rail structure 100 may be made of three blanks 31, 32, 33 configured to connect the first rear rail 10 with the second rear rail 20. Thus, the cross-member 30 may made of two blanks 31, 33 that substantially correspond to a transition between a rail 10, 20 and a cross-member 30, and a central blank 32 connecting the two lateral components 31, 33 together.

As can be seen in FIG. 6A, the overlapping regions 50 between different blanks may be designed to have different widths. For example, the overlapping regions 50 that substantially correspond to a transition between a rail 10, 20 and a cross-member 30 may have a width between 30 mm and 60 mm, e.g. in combination with substantially an entire width of the cross-member (i.e. across the U-shape and preferably including flanges of the U-shape). Or the overlapping region may extend over the whole width of the rear rail 10, 20 at least in the zone of the transition of the rails to the cross-member and e.g. over the whole width of the cross-member.

Further, the width of the overlapping regions 50 between the blanks 31, 33 and the central blank 32 may be between 10 mm and 30 mm. In this case, the overlap extends over the width of the central blank 32 (i.e. the width of the cross-member) and the overlap extends e.g. 10-30 mm along the transverse direction of the vehicle (the longitudinal direction of the cross-member). The widths of the overlapping regions 50 may be modified to adapt the mechanical properties of the unitary rear rail structure 100 to different applications.

Further, FIG. 6A illustrates that the rear rails 10, 20 may comprise two regions made of materials with different mechanical properties. For example, the first regions 11, 21 of the first and second rear rails 10, 20 respectively, may be made of steel with high mechanical properties, e.g. 22MnB5 or 37MnB5. In addition, the second regions 12, 22, of the first and second rear rails 10, 20 respectively may be made of a steel with lower mechanical properties, e.g. a more ductile steel. The blanks of the first and second regions 11, 12, 21, 22 of each rear rail 10, 20 may also define overlapping regions 50. The width of the overlapping regions in the rails may be at least 10 mm, and specifically between 10 and 50 mm (i.e. the overlapping region extends substantially over the width of the rail portion, and the overlap is 10-20 mm in the longitudinal direction of the vehicle).

In some examples, the cross-member 30 may be formed of materials with different mechanical properties. For example, the blanks making up the lateral sides 31, 33 of the cross-member 30 may be made of the same steel or a different material than the blank making up the central portion 32 of the cross-member 30. The material used to manufacture the cross-member 30 may be any Usibor® and Ductibor® material previously disclosed, or any other suitable steel.

FIG. 6B shows that the first and second rear rails 10, 20 and the cross-member 30 may define a substantially U-shaped cross-section. Further, it also shows that the geometry of the cross-section of the unitary real rail 100 may vary along its length and width. Further, the cross-section may include one or more flanges, and this may also change at different regions of the first and second rear rails 10, 20 and cross-member 30.

In the illustrated example, one can see that the rear rails may have (mounting) flanges at an inner side, whereas at their outer side they don't have flanges, or they only have flanges from the transition to the cross-member forwards.

In the example of FIG. 6, and in the other examples, the blanks forming the overlapping region may be joined using spot welding or laser welding. Laser welding may include the use of a plurality of “stitches”, e.g. short straight welds. Laser welding may additionally or alternatively include a continuous weld along one or more, specifically all of the edges, of the overlapping region.

The use of longer welds rather than spot welds can avoid stress concentrations that may occur around spot welds. Avoiding stress concentrations can avoid or delay rupture in the case of an impact or crash of the vehicle.

The use of continuous welds along the edges of the overlapping region can be preferred in case fluid tightness is required. In certain areas of the vehicle, it may be important to avoid fluid, e.g. liquid leaks. The use of spot welds may leave some space between sub-blanks or blanks that are assembled with each other to form the combined blank, and fluid might escape through these small spaces.

The use of longer welds, and particularly the use of laser welding may also improve the stamping process and avoid a potential separation between blanks or sub-blanks during the stamping process.

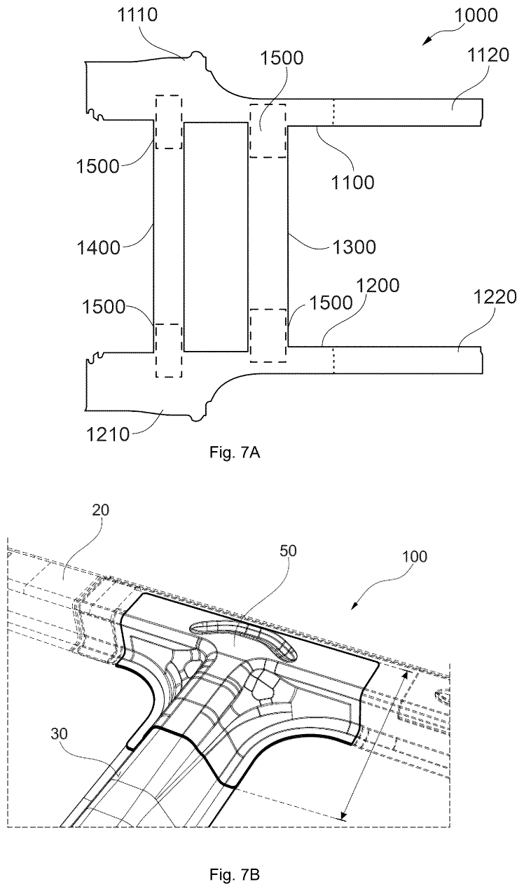

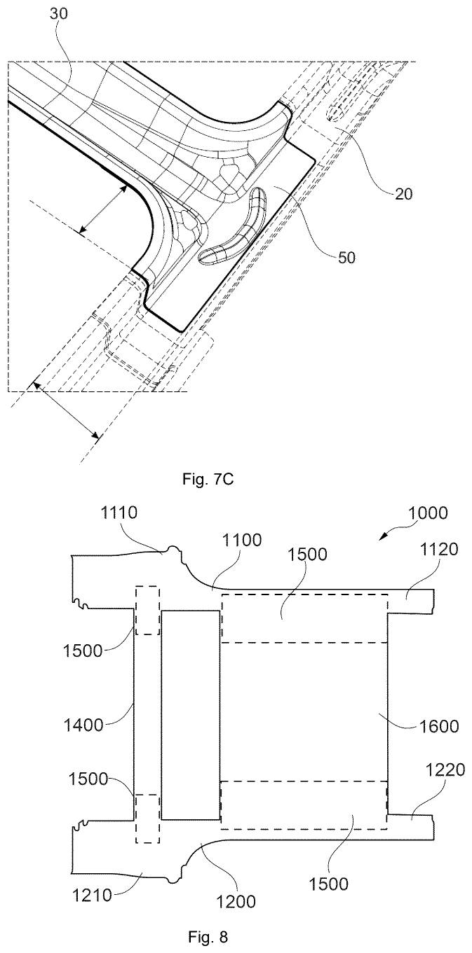

FIG. 7A schematically illustrates a top view of an example of a combined blank 1000 to form a unitary rear rail structure 100 according to the present disclosure. The combined blank 1000 in this example comprises four blanks 1100, 1200, 1300, 1400. The first and a second blanks 1100, 1200 may be configured to form rear rail structures 10, 20, and the third and fourth blanks 1300, 1400 may be configured to form cross-members 30, 40.

The blanks 1100, 1200, 1300, 1400 may be made of different materials and/or thickness. For example, the first and second blanks 1100, 1200 may be made of UHSS of a given thickness, or may be formed as Tailor Welded Blanks including a more resistant material such as UHSS, and a more ductile material, e.g. near the load receiving end. The third and fourth blanks may be formed of UHSS or other steels, and each may have the same of different thickness.

All blanks may be joined to each other to form the combined blank 1000. Then, the combined blank 1000 may be subjected to a forming operation, e.g. a hot stamping operation, to form a unitary rear rail structure 100 as disclosed above.

In some examples, portions of the structure (or portions of the combined blank 1000) may be subjected to a different heat treatment than other portions of the structure. For example, a first portion 1110, 1210 originally pertaining to the first and second blanks 1100, 1200 may be cooled at high cooling rates to reduce the temperature of the portion rapidly and obtain a hard martensitic microstructure; and a second portion 1120, 1220 originally pertaining to the first and second blanks 1100, 1200 may be cooled down at a lower cooling rate to obtain a softer microstructure, including e.g. bainite, ferrite and/or perlite.

In the example illustrated in FIG. 7A, all blanks 1100, 1200, 1300, 1400 have a thickness between 1 and 2.5 mm, but blanks with other thicknesses may also be used.

Further, some of the blanks 1100, 1200, 1300, 1400 in FIG. 7A form an overlapping region 1500. Particularly, one or more transitions between rail portions and cross-member portions may be reinforced by using an overlapping region. The overlapping region may be substantially or predominantly located within the rail portions.

FIGS. 7B and 7C schematically illustrate a portion of an example of a resulting unitary rear rail structure. In these figures, the overlapping region 50 at the transition between rail portion 20 and cross-member portion 30 may be seed.

It may be seen that the overlapping region has a significant length and width to increase stiffness and strength at the transition between rail and cross-member. A length of the overlapping region, as indicated in FIG. 7B may be e.g. between 15 and 30 cm, and particularly between 20 and 25 cm. As may be seen in the bottom view of FIG. 7, the overlapping region extends about 12-20 cm along the length of the cross-member and extends substantially over the whole bottom of the U-shape of the rail portion.

In this example, the width of the overlapping region corresponds to the width of the cross-member portion 30. And the width of the overlapping region may flare out, optionally both forwards and rearwards in the rail portion, as illustrated in FIG. 7C. E.g. the transition region may flare rearwards and forwards by 2-10 cm, specifically 3-8 cm.

As discussed in relation with the unitary rear rail structure 100, the combined blank 1000 may comprise a different number of blanks. For example, the combined blank 1000 may comprise two blanks, three blanks or more than four blanks.

FIG. 8 schematically illustrates a top view of another example of a combined blank 1000 to form a unitary rear rail structure 100 according to the present disclosure. The combined blank in FIG. 8 also comprises four blanks 1100, 1200, 1400, 1600. First and second blanks 1100, 1200 are configured to form rear rail structures (10, 20 in FIG. 1) and a third blank 1400 is configured to form a cross-members (30, or 40 in FIG. 1). Additionally, the combined blank 1000 comprises a fourth blank 1600 that is configured to form at least a part of a floor panel. In some examples, due to the lower mechanical requirements, the fourth blank 1600 may be made of a thinner material, e.g. between 0.7 to 1.5 mm, and may have lower mechanical properties than the remainder of the combined blank 1000 after forming.

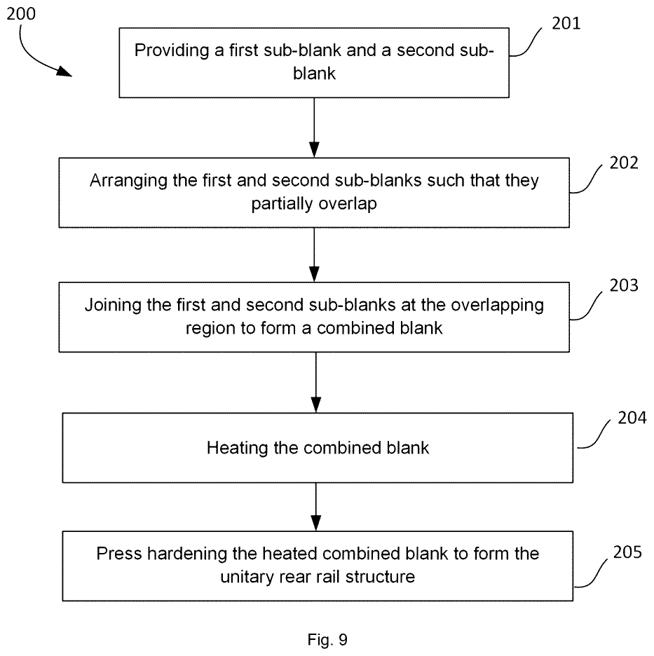

FIG. 9 illustrates a block diagram of a method 200 for manufacturing a unitary rear rail structure 100 comprising a first and a second rear rail and one or more cross-members, according to examples of the present disclosure.

The method 200 comprises, at block 201, providing a providing a first blank and a second blank 1100, 1300. The method further comprises, at block 202, arranging the first and second blanks 1100, 1300 such that the first blank 1100 partially overlaps the second blank 1300 in an overlapping region 1500. Further, the method comprises, at block 203, joining the first blank 1100 to the second sub-blank 1300 at the overlapping region 1500 to form a combined blank 1000. Additionally, the method includes, at block 204, heating the combined blank 1000 at least partially to above an austenization temperature. Furthermore, the method 200 comprises, at block 205, press hardening the heated combined blank 1000 to form the unitary rear rail structure 100.

Further, providing the combined blank 1000 comprises providing a first blank 1100 and a second blank 1300 such that the first blank 1100 partially overlaps the second blank 1300 forming one or more overlapping regions 1500. Additionally, the formed unitary rear rail structure 100 comprises a first and a second rear rail 10, 20 and one or more cross-members 30, 40.

As mentioned before, the method 200 provided allows forming a unitary rear rail structure 100 in a single forming step. Further, the formed unitary rear rail structure 100 has improved mechanical properties, specifically in the transition between the sub-blanks 1100, 1200, 1300, 1400 due to the overlapping regions 1500; 50.

The combined blank may be made of any type of hardenable steel, and particularly boron steel, as has been previously discussed for the unitary rear rail structure 100.

In examples, at least one of the overlapping regions 1500; 50 between the first blank 1100 and the second blank 1300 substantially corresponds to a transition between a rail 10 and a cross-member 30.

Further, the method 200 may comprise joining the first and second blanks 1100, 1300 together by spot welding.

Furthermore, the heating step 202 of method 200 may comprise heating a first region 1110 of the combined blank 1000 differently than a second region 1120 of the combined blank 1000. For example, the combined blank 1000 may be heated substantially homogenously above an austenization temperature, and subsequently a second region 1120 of the combined blank 1000 may be cooled below an austenization temperature.

In examples, the combined blank 1000 may be heated to above Ac3, and portions 1120, 1220 of the combined blank 1000 may be cooled to a temperature below Ac3, and even below Ac1 before deforming the combined blank 1000. The other portions may be maintained above Ac3 until the combined blank 1000 is deformed, or may be cooled temporarily but then heated up again to above Ac3.

Thus, the different temperatures can lead to different microstructures or strength properties being set in the respective portions of the unitary rear rail structure 100, in particular during a subsequent rapid cooling (“quenching”), e.g. in the dies of the press tool.

In examples, the combined blank is shaped during the press hardening step 203 to form a unitary rear rail structure and at the same time is quenched to below 400° C., or specifically below 300° C.

Further, the method 200 may be adapted to form a unitary rear rail structure 100 with any combination of the technical features previously discussed.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1-14. (canceled)

15. A method for manufacturing a unitary rear rail structure for a vehicle framework, the method comprising:
providing a first blank and a second blank,
arranging the first and second blanks such that the first blank partially overlaps the second blank in an overlapping region;
joining the first blank to the second blank at the overlapping region to form a combined blank;
heating the combined blank at least partially to above an austenization temperature; and
press hardening the heated combined blank to form the unitary rear rail structure, wherein,
the formed unitary rear rail structure comprises a first and a second rear rail portion and one or more cross-member portions, and wherein
the overlapping region substantially corresponds to a transition between the first rail portion and one of the cross-member portions, and wherein
wherein the overlapping region extends over an entire width of the cross-member and at least 20 mm into the rail portions.

16. The method of claim 15, wherein the joining the first and second blanks is carried out by spot welding.

17. The method of claim 15, wherein a first region of the unitary rear rail structure has an ultimate tensile strength after press hardening of 1,500 MPa or more, and a second region of the unitary rear rail structure has an ultimate tensile strength after press hardening between 700-1200 MPa.

18. The method of claim 17, wherein the first region of the combined blank is subjected to a different heat treatment than the second region of the combined blank.

19. The method of claim 15, wherein the overlapping region extends over a whole width of the rear rail portion least in the transition of the rail portions to the cross-member.

20. The method of claim 15, wherein an area of the overlapping region is 20-600 cm².

21. The method of claim 15, wherein the first and second rear rails comprise a first region configured for attaching the unitary rear rail structure to a chassis, wherein the first region has an ultimate tensile strength of 1,500 MPa or more.

22. The method of claim 21, wherein the first and second rear rails comprise a second region having an ultimate tensile strength between 700-1200 MPa, and a yield strength after press hardening between 500-900 MPa.

23. The method of claim 15, wherein at least one of the first and second rear rail portions and the cross-member portions has a substantially U-shaped cross-section, wherein
the U-shape has a bottom wall, a first side wall, a second side wall, a first lateral flange projecting outwardly at an end of the first side wall and a second lateral flange projecting outwardly at an end of second side wall.

24. The method of claim 23, further comprising attaching a cover plate attached to the first and second rear rail portions, and substantially closing the U-shaped cross-section.

25. A method for manufacturing a unitary rear rail structure for a vehicle framework, the method comprising:
providing a first blank and a second blank,
arranging the first and second blanks such that the first blank partially overlaps the second blank in an overlapping region;
joining the first blank to the second blank at the overlapping region to form a combined blank;
heating the combined blank at least partially to above an austenization temperature; and
press hardening the heated combined blank to form the unitary rear rail structure, wherein,
the formed unitary rear rail structure comprises a first and a second rear rail portion and one or more cross-member portions, and wherein
the overlapping region substantially corresponds to a transition between the first rail portion and one of the cross-member portions, and wherein an area of the overlapping region is 20-600 cm².

26. The method of claim 25, wherein the joining the first and second blanks is carried out by spot welding.

27. The method of claim 25, wherein joining the first and second blanks is carried out by remote laser welding.

28. The method of claim 25, wherein a first region of the unitary rear rail structure has an ultimate tensile strength after press hardening of 1,500 MPa or more, and a second region of the unitary rear rail structure has an ultimate tensile strength after press hardening between 700-1200 MPa.

29. The method of claim 28, wherein the first region of the combined blank is subjected to a different heat treatment than the second region of the combined blank.

30. The method of claim 25, wherein the overlapping region extends over a whole width of the rear rail portion least in the transition of the rail portions to the cross-member.

31. A method for manufacturing a unitary rear rail structure for a vehicle framework, the method comprising:
providing a first blank and a second blank,
arranging the first and second blanks such that the first blank partially overlaps the second blank in an overlapping region;
joining the first blank to the second blank at the overlapping region to form a combined blank;
heating the combined blank at least partially to above an austenization temperature; and
press hardening the heated combined blank to form the unitary rear rail structure, wherein,
the formed unitary rear rail structure comprises a first and a second rear rail portion and one or more cross-member portions, and wherein
the overlapping region substantially corresponds to a transition between the first rail portion and one of the cross-member portions, and wherein
the first rail portion has a U-shaped cross-section, and
wherein the overlapping region is located at a bottom wall of the U-shaped cross-section.

32. The method of claim 31, wherein the joining the first and second blanks is carried out by spot welding.

33. The method of claim 31, wherein joining the first and second blanks is carried out by remote laser welding.

34. The method of claim 31, wherein a first region of the unitary rear rail structure has an ultimate tensile strength after press hardening of 1,500 MPa or more, and a second region of the unitary rear rail structure has an ultimate tensile strength after press hardening between 700-1200 MPa.
